(19) United States
(12) Patent Application Publication
(10) Pub. No.: US 2005/0182681 A1
(43) Pub. Date: Aug. 18, 2005

(54) Money dispensing system

(76) Inventors: Thomas P. Bruskotter, Englewood, CO (US); Edward M. Swapp, Englewood, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/949,819

(22) Filed: Sep. 24, 2004

Related U.S. Application Data
(60) Provisional application No. 60/505,779, filed on Sep. 25, 2003.

(51) Int. Cl. G06F 17/60

(52) U.S. Cl. 705/15; 705/17

(57) ABSTRACT

A money managing system for use in a business setting is provided that allows for automated ordering, payment and receipt of change. In a fast food setting, a customer uses a user interface unit to enter an order, indicate the completion of an order and indicate a desired method of payment. The user can then insert coins, paper bills, credit cards, coded tickets, or some combination thereof, in payment. If no change is due, a dispenser is used to generate a receipt. In cases where change is due, the dispenser may further issue a code, for example, in the form of a barcode. The customer's food order can be picked up, for example, at an order window where money handling is not required. The customer may then use the ticket at a money dispensing machine to receive change in the form of coins and/or bills.

### CROSS REFERENCE TO RELATED APPLICATIONS

This application claims priority under 35 U.S.C. 119 to U.S. Application No. 60/505,779 entitled “Money Dispensing System” filed on Sep. 25, 2003, the contents of which are incorporated herein by reference.

### FIELD OF THE INVENTION

The present invention relates in general to automated systems for dispensing money, i.e., coins and/or paper money. In particular, the present invention is directed to systems for dispensing money in response to a code entered by a user, where such a code is based on a transaction involving the user.

### BACKGROUND OF THE INVENTION

Many types of businesses include outlets for receiving payments, completing transactions and paying money to customers or other individuals. Examples include retail stores such as grocery and department stores, restaurants including fast food restaurants and gaming establishments. In the case of retail stores and restaurants, the transaction generally involves the purchase of goods and/or services. Money is received from a customer in payment for the same and money may be paid to the customer as change due. In the case of gaming establishments, the transaction may involve a game of chance. Payment may be received from a participant in the form of a wager and a payment may be made to the participant as winnings or unused credit.

Money handling is often problematic in these contexts. In particular, manual money handling may result in mistakes and provides opportunity for theft. Moreover, the need for money handlers increases labor costs. Money handling also often slows transaction processing, thereby further limiting the profitablilty of a business outlet.

Indeed, there is a growing trend towards automation of transaction completion and money handling. For example, an increasing number of grocery stores and retail otlets include automated checkout lines where customers can utilize barcode scanners, credit card readers, and money accepting/dispensing machines in a self-service environment. More recently, certain fast food restaurants have experimented with touch screen kiosks where customers can enter their own orders. Additionally, some casinos have begun to issue coded tickets, e.g., tickets with barcodes, in lieu of dispensing money or tokens from slot machines or other automated gaming devices.

While all of these automated or partially automated systems provide certain advantages, there remains significant work to be done in order to fully realize the potential advantages of automated transaction processing in such environments. In the case of the retail outlet examples noted above, a large number of automated checkout sites are required to accommodate the desired volume of customer throughput. Accordingly, there are a large number of money machines that need to be stocked with coin and paper money, maintained and secured. In the case of the casino example noted above, difficulties associated with stocking, maintaining and securing automated gaming machines are reduced, but money handling is still generally handled manually, i.e., the coded tickets must be presented to a worker who makes change. Accordingly, there remains a potential for errors or theft and labor costs are increased. Similarly, in the fast food example, money handling is still generally performed manually. Accordingly, there remain significant challenges to fully realizing the benefits of automated transaction processing.

### SUMMARY OF THE INVENTION

The present invention is directed to a system for automated money handling for use in a variety of business environments. The system successfully automates money handling thereby reducing theft, errors and labor costs. Moreover, the system allows for a reduction in labor and costs for stocking, maintaining and securing money handling machines thereby yielding additional savings and providing greater operator convenience.

In accordance with one aspect of the present invention, a money dispensing system is provided. The system includes a first input for receiving code information and money due information concerning amounts of money due to an individual associated with corresponding transactions. For example, the first input may be a network port for providing information associating a given code with a given amount of money due related to the code. The money dispensing system further includes a second input for receiving a code from an individual. For example, the second input may be a barcode reader, a keypad for receiving an alphabetical, numeric or alphanumeric code, or a microphone for receiving the code from an individual by voice. Further alternatives include an optical reader for reading a fingerprint or other distinguishing feature of the individual, a card swipe or other magnetic reader or other suitable means for receiving an input from the user that may be associated with or encoded to an amount of money due to the individual. The money dispensing system further includes logic for associating the code received from the individual with an amount of money due in connection with the code and a money dispensing mechanism operatively associated with the logic, for dispensing money in the amount due. In this regard, the logic may include structured storage such as a database whereby a code can be related to an amount due. The money dispensing mechanism preferably is operative for dispensing coins and/or paper money in the exact amount due.

In accordance with a further aspect of the present invention, a money managing system is provided for use in connection with a business. The money managing system comprises: at least one customer transaction processing terminal operative for executing a transaction and generating electronic code information including a code and a money amount associated with the code, and a money dispensing machine operative for receiving the code from an individual, obtaining the code information from the transaction processing terminal and dispensing money in the indicated amount in response to receiving the code. For example, the transaction processing terminal may be an order kiosk in a fast food restaurant, a checkout stand at a retail outlet or the gaming machine of a casino. Preferably, the money dispensing machine is interconnected to a plurality of transaction processing terminals so as to provide centralized change dispensing capability. Such centralized change dispensing reduces stocking, maintenance, and security requirements. The transaction processing terminal may be interconnected to the money dispensing machine by any appropriate means such as a local area network, a wide area network, wireless interconnection or the like.

In one arrangement of the present aspect, the transaction processing terminal and money the dispensing machine are operatively interconnected to a processor. Such a processor may be operative to receive and store code information from the transaction processing terminal. Accordingly, the stored information may be subsequently provided to either a transaction processing terminal, or, a money dispensing machine. In this regard, a customer may in lieu of receiving change for a particular transaction retain the code information for future use. That is, at a subsequent time the customer may provide the code information to another transaction processing terminal for payment of another purchase. For example, the customer may retain code information in the form of a voucher or ticket (e.g., system credit) that may be utilized at a later time. Of course, the customer may also at a later time present the code information to a money dispensing machine for receipt of money in an amount due.

Utilization of the processor also allows for operatively interconnecting businesses located at different locations. In this case, the code information received from a first business location may be utilized at a second business location. For instance, restaurants of a fast food chain may be operatively interconnected by a remote server to allow code information to be stored at a centralized location. As will be appreciated, processors at different business locations may be operatively interconnected over any appropriate network. Such network connection include LANs, WANs, wireless networks, wireline networks, and, of course, the Internet.

Typically, the food order received at the transaction processing terminal is provided to a food preparation area. For instance, in a fast food restaurant setting, the food order may be provided to a kitchen area such that kitchen staff may prepare the food items of the order. In order to receive the order information, the user interface of each transaction terminal may incorporate any or all of the following: a keypad, a display screen (which may be a touch screen display) and/or a microphone. In the latter regard, the input device may allow for receiving verbal input information. Where a display is utilized, the display may allow: providing user prompts to facilitate the purchase transaction; displaying items for sale; and/or providing information associated with the items for sale.

The payment receiving device is preferably operable to receive payment in various forms. For instance, the payment receiving device may include a card reader for reading credit and/or debit cards. Furthermore, the receiving device will typically be operative to receive paper currency, coins and/or system credit such as vouchers, tickets and/or user codes. Such system credit may be embodied in machine readable media.

The code generator may be operative to provide coded information in any applicable media. This media may be visual where a code is displayed to a user. Alternatively, the code may be fixed in a media such as a receipt, voucher and/or ticket. In one embodiment, code information provided with this media is machine readable such that the user may conveniently provide the information to the money dispensing machine. Such machine readable information may include, without limitation, barcodes and/or magnetic coding.

The money dispensing machine is preferably operable to provide exact change for a user. In this regard, the machine will typically be operative to provide paper currency as well as coins. Furthermore, to facilitate receipt of any coded information the dispensing machine may include any or all of: a keypad, a microphone and/or a reader for reading machine readable code information. For instance, if the coded information is in the form of a barcode, the money dispensing machine may include an optical scanner. In a further arrangement, the money dispensing machine may also be operative to function as an automated teller machine.

In another aspect of the present invention, a money managing system is provided for use in connection with a fast service business. The money managing system comprises at least one transaction processing terminal operative to receive a food order, a money receiving machine operative to receive payment for such an order, a processor operatively linked to the transaction processing terminal for providing order information to a kitchen associated with the restaurant and money dispensing machine operative for generating an output in response to the received payment.

The transaction processing terminal, money receiving machine and money dispensing machine may all be located at a common location. Alternatively, the money dispensing machine may be located at a location separate from the transaction processing terminal and money receiving machine. In this regard, the money dispensing machine may be operatively interconnected to a plurality of transaction processing terminals/payment machines.

### BRIEF DESCRIPTION OF THE DRAWINGS

For a more complete understanding of the present invention and further advantages thereof, reference is now made to the following detailed description taken in conjunction with the drawings in which:

FIG. 1 is a schematic diagram of an automated filling station network in accordance with the present invention;

FIG. 2 is a schematic diagram showing the components at an individual filling station site of the network of FIG. 1;

FIG. 3 is a flow chart illustrating a pump system related process according to the present invention;

FIG. 4 is a flow chart illustrating a change dispenser system related process according to the present invention;

FIG. 5 is a chart outlining various functions and implementation options of the network of FIG. 1;

FIG. 6 is a schematic diagram of an automated filling station network in accordance with the present invention;

FIG. 7A-7D are partially schematic diagrams showing implementations of the invention in connection with a retail store, fast food and gaming establishment environments, respectively.

### DETAILED DESCRIPTION OF THE INVENTION

The present invention relates in general to a money dispensing machine, transaction processing systems including a money dispensing machine, and related methodology. The following description first sets forth the invention in connection with a filling station application. Thereafter, the invention is described in the contexts of retail store, fast food and gaming establishments.

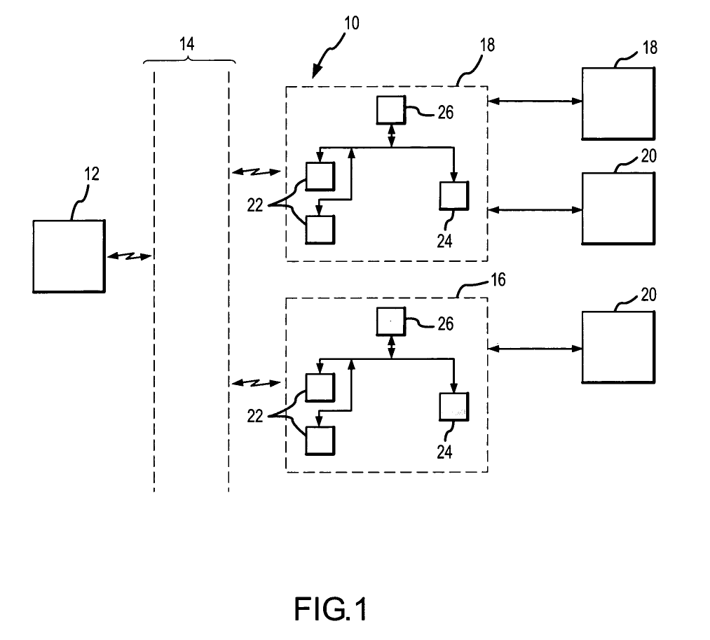

Referring to FIG. 1, an automated filling station network is generally identified by the reference numeral 10. Generally, the network 10 includes a number of filling station sites 16 that communicate with a remote host computer 12, via a public or private communications network 14, such as the Internet. Although the illustrated network 10 is shown as including only two filling station sites 16, it will be appreciated that any number of filling stations may be included in the network 10.

Each filling station site 16 includes a number of fuel pump systems 22, at least one change dispenser system 24, and a site controller 26. Again, although the illustrated filling station sites 16 are shown as including only two fuel pump systems 22, each site 16 can include any number of fuel pump systems 22. Similarly, although a single change dispenser 24 per site 16 is preferred for ease of maintenance, any number of change dispensers 24 per site 16 can be included as desired. For example, certain aspects of the present invention may be implemented in connection with embodiments where the change dispenser can be incorporated into the individual pump systems rather than provided separately as shown. The site controller 26 implements logic as will be described below. The logic can be embodied in hardware, firmware or software. Preferably, the logic is embodied in software so as to facilitate remote or onsite revisions and updates without changing or modifying hardware. A number of interfaces are also shown at each filling station site 16. Such interfaces can include a store data system interface 18, and maintenance and restocking interfaces 20. The store data system interface 18 is particularly applicable where the filling station site 16 is associated with a convenience, discount or other store. The interface 18, which may be any suitable network connection, allows the store data system and the network data system to exchange data for inventory, accounting and other purposes. The maintenance and restocking interfaces 20, which may include a user interface device such as a keyboard and a scanner for reading identification cards, are provided for tracking refueling of the filling station site 16, restocking of the change dispenser 24, onsite administrative updates, and other purposes.

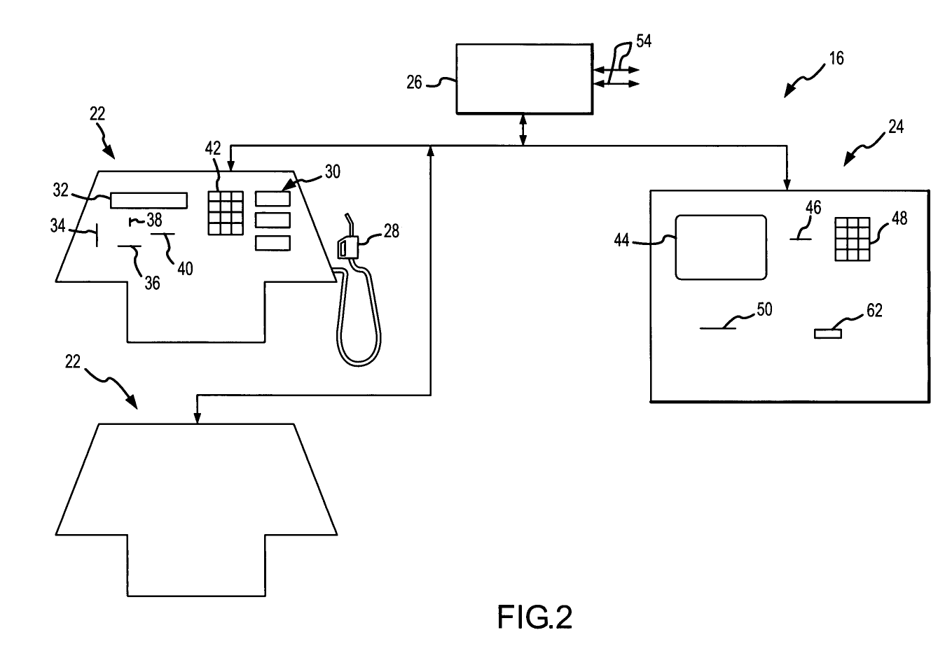

Additional details of a filling station site 16 are shown in FIG. 2. The illustrated pump system 22 can receive payment in a variety of forms including cash, credit or debit cards, and previously issued system credit, i.e., by way of a balance code entered on a keyboard or, optionally, a coded voucher. In this regard, the pump system 22 includes some or all of a card reader 34, such as a conventional magnetic card swiper, a bill acceptor 36, an optional coin acceptor 38, and an optional voucher reader 40. Typically, the pump system 22 will include at least a card swiper and a bill acceptor. The voucher reader 40, if provided, receives and processes vouchers containing machine readable code information. For example, the machine readable code information may be provided in the form of a barcode, magnetic coding or other machine readable format. The pump system 22 also includes a message display 32 such as a monochromatic dot matrix display system or other video system for displaying various messages such as instructions, prompts, advertisements, and error messages. A user input device such as a key pad 42 may be also provided for various user input functions such as (optionally) selecting payment type, entering a security or prior payment balance code, and approving payment amounts. The pump system 22 also includes conventional pump components such as a fuel dispenser nozzle 28 and a pump display 30 for displaying a running transaction amount, price information and fuel amount.

The illustrated change dispenser system 24 receives code information input by a customer, retrieves associated coded balance information from the site controller 26 and dispenses change in the form of bills and coins. The system 24 which may be, for example, a cash machine manufactured by Diebold, Inc. of Canton, Ohio. The cash machine will generally include: a dispenser display 44 for displaying instructions, prompts, advertisements and the like; voucher reader 46, if provided, receives and processes vouchers containing machine readable code information; a user input device such as a key pad 48 for manually inputting code information, identification information or the like; a bill dispenser 50 providing change in the form of bills such as some or all of United States twenty dollar bills, ten dollar bills, five dollar bills and one dollar bills; and a coin dispenser 52 for dispensing change in the form of coins such as some or all of quarters, dimes, nickels and pennies. The cash machine may also include additional features associated with conventional ATM's. For example, the cash machine may provide cash withdrawal functions, check depositing functions, balance inquiry functions, and the like.

For simplicity, the change dispenser system 24 may use only a smaller set of denominations. For example, dimes may be eliminated as they can be readily replaced by nickels. In one embodiment, when a malfunction occurs in the coin dispenser 52, the maximum amount of change will be dispensed to the customer. For example, if the quarters dispenser malfunctions and the change due would ordinarily entail one or more quarters, the customer may be given the change due less the quarters, together with a code associated with the amount owed due to the undispensed quarters. The code can then be used for fuel or, at a later date or separate machine, to obtain change. This may be accomplished in response to a malfunction signal generated by the quarter dispenser. Alternatively, one of the other coin dispensers, e.g., the nickel dispenser, may be used to dispense the appropriate amount of change to the customer. If a difference still remains between the dispensed amount and the amount owed, the customer will receive new code information that allows the change to be received at a later date.

The pump system 22 and the change dispenser system 24 are interconnected to form a network. The network also includes the site controller 26 that performs a number of functions including monitoring pump system operations, generating and recording codes together with associated balances, receiving code inputs from the cash dispenser system 24, and controlling operation of the cash dispenser system 24 to provide change. The site controller 26 also includes at least one communication port, generally identified by arrows 54, such as for modems, alarm paging, or linking with change back machines. The communication ports allow the site controller 26 to communicate with external card authorization systems, such as the BUYPASS, PAYPOINT or other credit card authorization network, and the host computer 12 (FIG. 1) of the automated filling station network 10. Multiple parts, e.g., more than two, may be used. The site controller 26 of the illustrated embodiment is a computer and can be any suitable processing system such as, for example, an Intel PENTIUM based IBM compatible system with at least a 1 GB hard drive and 16 MB of RAM. The site controller 26 may run Microsoft Windows 95 or another operating system.

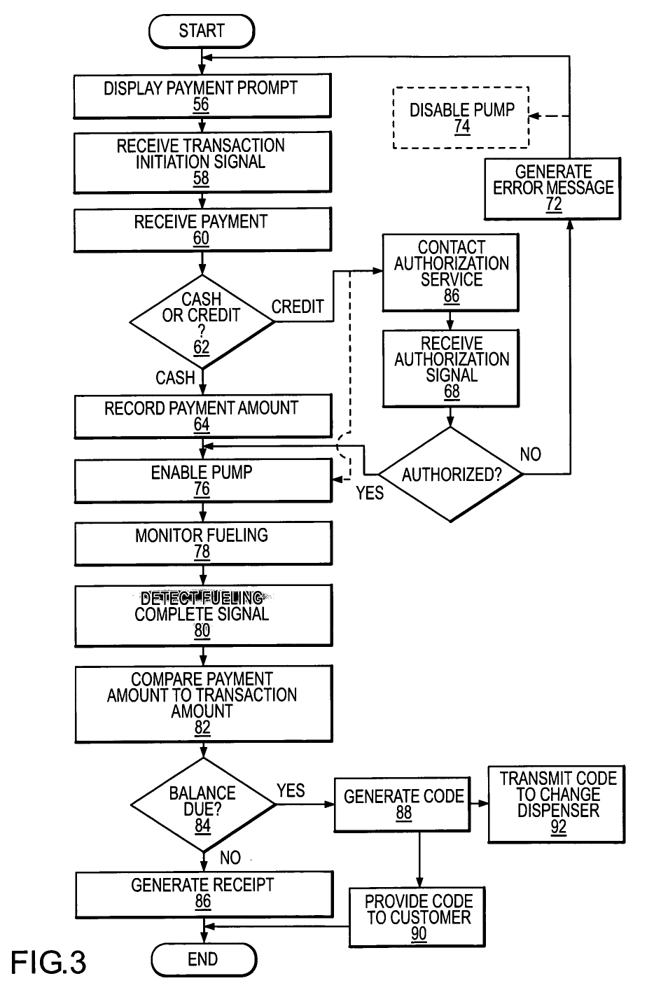

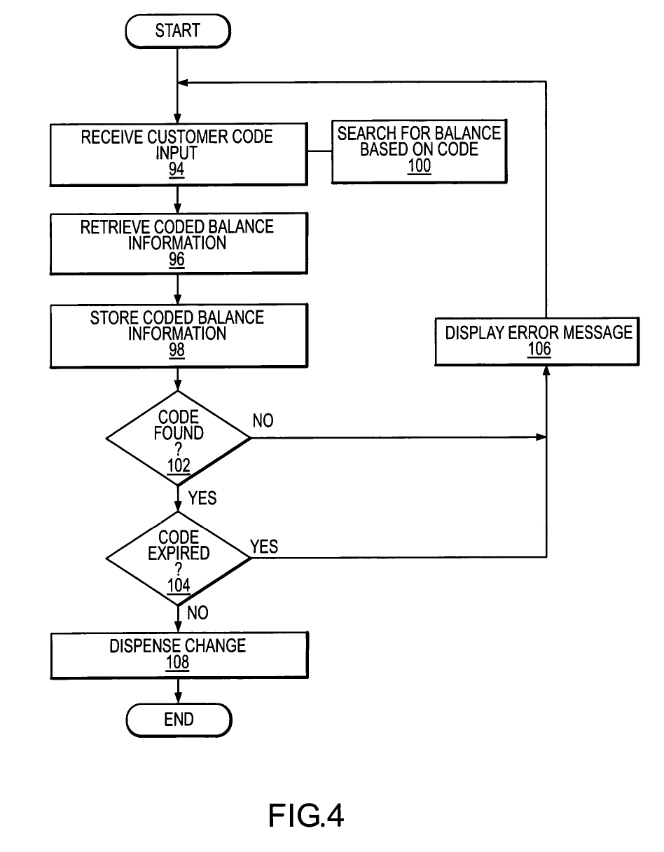

Various functions that are executed by the site controller 26 are outlined in the flow diagrams of FIGS. 3 and 4. More specifically, FIG. 3 illustrates a number of pump system related processes and FIG. 4 illustrates various cash dispenser system related processes.

Referring to FIG. 3, a pump system may be programmed to continuously or periodically display (56) a payment prompt such as “select payment type” or “insert payment” between transactions. A customer initiates a transaction by inserting a card, cash, or (where applicable) a credit voucher. The controller receives (58) a corresponding transaction initiation signal and the pump system receives and credits (60) payment. Payment is typically received at the pump system by receiving currency through the bill acceptor or by obtaining authorization of a credit or debit card in a specified amount (even though only the transaction amount may eventually be debited from the corresponding card account). Further processing of the transaction depends on whether the customer has selected cash or credit (62).

For cash payments, the control system monitors the amount of currency received through the bill acceptor and records (64) the total payment amount. The bill acceptor 36 generally comprises an optical scanner and a bill stacking system (not shown). A bill fed into the bill acceptor 36 is optically scanned by the optical scanner. The optical scanner produces a signal that identifies the denomination of the bill. The bill is then routed through the bill stacking system. The acceptor 36 may further include a malfunction signal generator operative to transmit malfunction signals to the control system in the event of a bill jam. When a bill jam is reported (e.g., automatically in response to a malfunction signal or manually by a customer), an operator and/or the control system can then verify the amount owed. More specifically, the record (64) is not completed until the bill has been stacked within the bill stacking system. If a malfunction, i.e., a bill jam occurs, the malfunction generally occurs within the bill stacking system. As a result, the record (64) is not posted to the control system and the customer does not receive credit for the jammed bill. An error message may then be generated by the control system (72) informing the customer of the malfunction. The signal, identifying the denomination of the jammed bill can then be used to enable (76) the pump or used to provide a code to the customer. In addition, as described in greater detail below, the error message and the denomination of the jammed bill is generally communicated to a remote computer center. The remote computer center can add code information and associated balance due information to a data base based on the denomination of the jammed bill which allows the customer to input the code into the pump system and enable (76) the pump. In another embodiment, the remote computer center can provide direct customer service by enabling (76) the pump or otherwise assisting the customer.

For credit payments, the control system contacts (66) an authorization service, waits for a response and receives (68) an authorization signal. If the card is not approved, the control system generates (72) an error message which is displayed to the customer. If the card is authorized, or if the customer pays in cash, then the pump is enabled (76) and the fueling process can begin.

Alternatively, the pump may be enabled prior to obtaining authorization as indicated in phantom on FIG. 3. If authorization is subsequently denied, then the control system can disable (74) the pump after fueling has been initiated. It will be appreciated that such immediate pump enablement entails a risk of loss by the fuel vendor. However, it is anticipated that any such losses will be minimal due to the speed of operation of the authorization system. Any such losses may be justified by the improved customer convenience and customer throughput resulting from reduced authorization delays,

During the fueling process the control system monitors (78) the fueling process to detect (80) a fueling complete signal. Depending upon the type of pump system employed, such a fueling complete signal may be generated in response to hanging up the pump nozzle or in response to manually turning the pump off by flipping a pump lever. Upon detecting the fueling complete signal, the control system communicates with the pump system to determine the transaction amount and compares (82) the payment amount to the transaction amount to determine whether a balance is due (84). If no balance is due, the control system will only generate a receipt (86) if requested by a customer, and the pump system related process is complete. On the other hand, if a balance is due, the control system generates (88) a code and associates the code with the balance due. The code can be generated by any suitable software such as random or modified random number generator (excluding previously used codes), or custom software for selecting predetermined codes from a code database. The control system relates the code to the corresponding balance and stores the code and balance in a coded balance data base that is indexed by code. In this manner, the coded balance information can be transmitted (92) to the change machine in response to a code input by the user.

The code can be provided (90) to the customer in any suitable form. For example, the code can be printed on the transaction receipt that is reported to the customer. Alternatively, a code such as a password or character string can be displayed to the customer on the pump system monitor. As a further alternative, it is anticipated that the pump system may be provided with the capability to issue a ticket or voucher to the customer that includes optically or magnetically encoded information corresponding to a numeric or alphanumeric code.

Once the customer has received the code, the customer may either retain the code and receive credit for the balance due in a subsequent fueling transaction at a site within the automated filling station network, or the customer may proceed with the code to the change dispenser system to receive change in the form of currency. FIG. 4 illustrates the change dispenser system related process. The process can be implemented by the customer in response to instructions and/or prompts displayed on the change dispenser system monitor. Upon approaching the change dispenser system, the customer initiates the change dispenser system process by entering the code supplied by the pump system e.g., by entering the code manually or, where available, by inserting a machine-readable voucher. The code is transmitted to the control system by the change dispenser system. The control system receives (94) the customer code input and retrieves (96) the coded balance information which has been stored (98) by the control system in computer memory. More particularly, the coded balance information is retrieved by searching (100) through the code indexed balance information data base based on the received code. If the code is found (102) and has not expired (104), then the change dispenser system dispenses (108) change in the form of currency in the amount indicated by the coded balance information. In this regard, it will be appreciated that network operators may desire to attach expiration dates to particular codes (e.g., 90 days after transaction date) for bookkeeping purposes. If the code is not found, or is expired, an error message is displayed (106) to the customer and the process may be restarted.

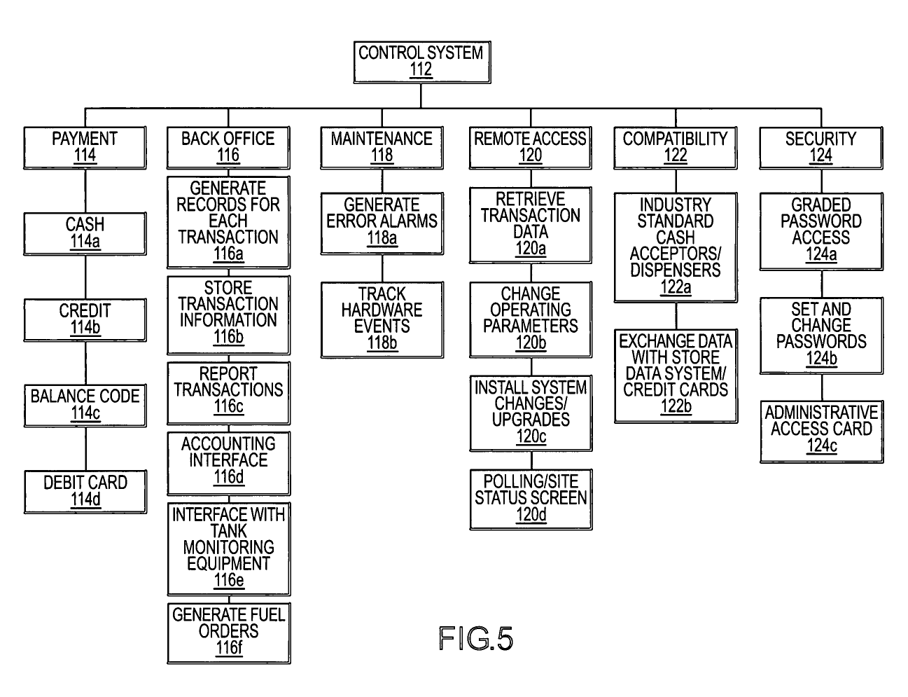

FIG. 5 shows a number of functions and implementation options for the control system of the automated filling station network. These functions can be executed by the remote host computer, the site controller or other elements of the overall control system. The illustrated functions can generally be grouped into the following categories: 1) payment functions (114); 2) back office functions (116); 3) maintenance functions (118); 4) remote access functions (120); 5) compatibility functions (122); and 6) security functions (124). The payment functions (114) include recognizing and crediting customer payments received in the form of cash (114a), a credit card (114b), balance codes (114c) manually entered or encoded into credit vouchers, and a debit card (114d). The back office functions (116) can be varied as desired depending on the filling station environment and operator preferences. In the illustrated embodiment, the back office functions implemented by the control system (112) include generating (116a) records for each transaction, storing (116b) transaction information for backup record keeping in the case of transmission failures between the filling station site and the remote host computer, reporting (116c) the transaction information (e.g., in the form of printouts) to the system administrator and providing (116d) an accounting interface between the control system and accounting programs associated with the remote host computer or a data system of a store associated with the filling station, The back office functions (116) also include providing (116e) an interface with tank monitoring equipment to track fuel inventory and generating (116f) fuel orders when fuel inventory reaches a selected level. The fuel orders can be transmitted to the host computer or directly to a supplier via a pager or computer interface.

The maintenance functions (118) include generating (118a) error alarms and tracking (118b) hardware events such as malfunctions, revisions or tampering. The error alarms may take various forms such as transmitting an error message to the host computer or paging a servicing agent. The nature of the error alarm generated may depend, for example, on the urgency of the identified error, the time of day, etc. Error messages may include some or all of the following: 1) pump off line; 2) pump paper is out; 3) pump paper is low; 4) credit card interface is down; 5) pump not reset for next sale; 6) receipt paper jammed; 7) bill acceptor jammed; and 8) emergency shutoff activated.

The remote access function (120) allows the filling station site to be monitored and controlled via the remote host computer. These functions include retrieving (120a) transaction data, changing (120b) operating parameters such as fuel prices, expiration periods for codes, prioritization of error alarms, installing (120c) system changes and upgrades by downloading codes from the remote host computer to the site controller, and polling (120d) the filling station sites and displaying the site status on a monitor associated with the remote host computer. Preferably, the site status for a given site is formatted to show all status information for a particular site on one screen. The status information can include, for example, the current status and history of all alarm parameters.

The compatibility functions (122) ensure that the control system can communicate with various related data systems. For example, the fuel pump systems preferably employ industry standard cash acceptors and dispensers. Accordingly, the compatibility function (122) assures compliance with such standards (122a). In addition, in the case of a filling station site associated with a store, the control system may be designed for compatibility with the store's data system (122b) to exchange data for inventory and bookkeeping purposes. Similarly, the control system (112) may be programmed to accept the same credit cards under the same conditions as the store.

The security functions (124) are intended to discourage improper access to the network. The security functions (124) preferably define a number of security levels or grades (124a) for controlling access to the network. For example, a fuel vendor may be allowed access for the limited purpose of monitoring fuel inventory and reporting refueling levels. A vending machine servicing agent may be allowed access to the network for the limited purpose of monitoring coin and bill supplies and restocking as necessary. The control system also preferably allows passwords to be set and changed (124b) as desired from the remote host computer. Finally, the security system may verify (124c) administrative access cards which allow access to network administers for retrieving records, upgrading systems and performing other administrative functions.

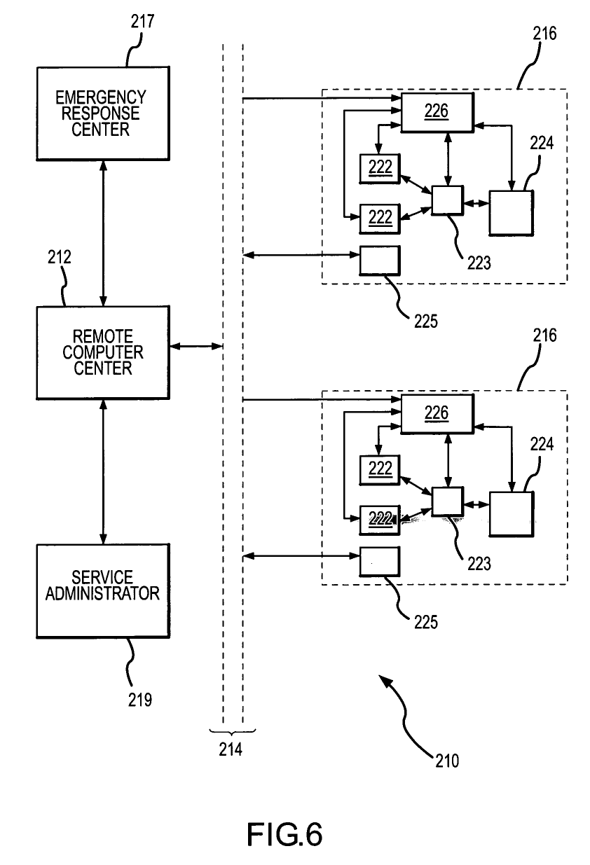

Referring to FIG. 6, another embodiment of an automated filling station network 210 is shown illustrating various functions and components of the present invention. Generally, the network 210 includes a number of filling station sites 216 that communicate with a remote computer center 212 via a public or private communications network 214. The network 210 further includes an emergency response center 217 and a service administrator 219, each in communication with the remote computer center 212. It will be appreciated that any number of these components may be included in the network 210. For example, a large number of filling station sites 216 may be controlled by a single remote computer center 212 while it may be appropriate to have a separate service administrator 219 and emergency response center 217 for each particular geographic area. Each filling station site 216 includes a number of fuel pump systems 222, an alarm system 223, at least one change dispenser system 224, at least one customer communication system 225, and a site controller 226. As described above, the site controller 226 implements logic embodied in software, firmware, and/or hardware for controlling operation of the filling station site 216.

Referring to FIG. 6, the network 210 includes a number of communication links to facilitate interaction of the various components of the network 210. During operation, a customer initiates a transaction by inserting a payment amount in the form of a card, cash, or a credit voucher at pump-system 222. Pump system 222 communicates with site controller 226 which authorizes fueling, calculates a balance code at the end of fueling, and transmits the code to pump system 222 for display and/or dispensing to the customer. The customer may then enter the balance code at the change dispenser 224 which communicates with the site controller 226 and which then dispenses change to the customer based on this communication. Information or data regarding the amount of fuel pumped, the currency received at each pump system 222, and the currency dispensed by the change dispenser 224 may be stored by the site controller 226. Periodically, this information may be transmitted or downloaded to the remote computer center 212 for further processing. In this manner, the remote computer center 212 may include logic for processing this information to determine servicing schedules for each filling station sites 216 and then communicating these service schedules to the service administrator 219, thereby facilitating timely and cost effective maintenance of the filling station sites 216 within network 210. The remote computer center 212 may also process this information to determine daily or periodic sales information (e.g., profit) for accounting and administrative purposes.

As may be appreciated, fuel prices may fluctuate periodically and may vary based upon geographic location because of competitive forces, changes in supply and demand, and other market related reasons. It may be desirable to set or establish the fuel price at each filling from the remote computer center 212 to save the cost of periodically, often daily, servicing each filling station site 216 merely to change fuel prices. In this regard, the remote computer center 212 may be operated to monitor and establish fuel prices within network 210. The remote computer center 212 may transmit a new tire1 price to site controller 226 at a filling station site 216. The site controller 226 employs this new fuel price when determining transaction amounts associated with future fueling transactions. The site controller 226 also operates the pump system 222 to display the new fuel price to customers. The site controller 226 or remote computer center 212 may similarly operate any associated display systems (e.g., automated bill boards on site or offsite, such as along a highway) visible to customers at the filling station site 216 or at separate locations.

If a customer experiences difficulties in operating the pump system 222 or in obtaining change at change dispenser 224, the customer may operate customer communication system 225 to communicate with the remote computer center 212 via communications network 214. For example, customer communication system 225 may comprise a telephone located near change dispenser 224. When a change dispenser malfunctions, the customer may use the telephone of the customer communication system 225 to call (e.g., free of charge with a 1-800 number) the remote computer center 212. The remote computer center 212 may respond by transmitting a new balance or refund code to the customer for immediate or later use. As can be appreciated, the appropriateness of a refund may be verified by cross-checking the customer's original balance code (e.g., has it been previously dispensed) and/or the customer's fuel authorization code. With a refund code in hand, the customer may operate the change dispenser to obtain currency. If a continuing malfunction is experienced, the remote computer center 212 can relay this information to the service administrator 219 for correction of the problem.

The filling station site 216 further includes an alarm system 223 interconnected with the pump systems 222, the change dispenser 224, and the site controller 226. The alarm system 223 may be designed to provide continuous monitoring of the physical integrity of the pump systems 222 and the change dispenser 224 and to transmit current status and alarm signals to the site controller 226 for further processing. For example, if physical damage occurs at a change dispenser 224, the alarm system 223 transmits an alarm signal to site controller 226. Site controller 226 processes and transmits this information via communication network 214 to remote computer center 212. Remote computer center 212 receives this information, determines an appropriate alarm response, and transmits this alarm response to the emergency response center 217. In this manner, the automated, and often remotely located, filling station sites 216 can be efficiently and cost effectively monitored and maintained against physical damage that would detrimentally affect continuing operation.

As may be appreciated, the change dispenser 224 may have an integral or substantially integral alarm system 223. For example, the change dispenser 224 may be an ATM-type machine, such as that manufactured by Diebold, Inc., having an integral security system (e.g., alarm systems) that includes integral camera surveillance, electronic access locks, alarm sensors, and seismic vibration detectors. Referring to FIG. 6, the alarm system 223 of the present invention may be integral to change dispenser 224 with the alarm system 223 including a sensor(s) for monitoring the physical integrity of the change dispenser 224 and communication ports for linking the alarm system 223 to a communications network 214 via site controller 226. The alarm system 223 may further include a sensor(s) placed on the pump systems 222 interconnected to the integral portion of the alarm system 223 at the change dispenser 224. In this regard, the sensor(s) of the pump systems 222 monitors physical integrity of the pump systems 222 and, specifically, of the cash receipt portions. In this manner, the alarm system 223 may be employed to transmit current status and alarm signals regarding the filling station site 216 to the remote computer center 212, which may forward alarm signals to the emergency response center 217, as appropriate. Additionally, the alarm system 223 may be directly linked (e.g., bypassing the site controller 226) to an emergency response center 217, such as a police station or a private security service, to facilitate prompt response to any emergency signals transmitted by the alarm system 223.

The automated filling station network of the present invention provides on the spot change in the form of currency or credit voucher for use and subsequent fueling transactions as desired by the user. In addition, the automated filling station network of the present invention allows the remote computer center 212 to perform diagnostic evaluation of malfunctions. The invention also enables various malfunctions such as bill jams to be immediately verified and addressed while the customer is on site and without requiring the intervention of an attendant. Furthermore, the remote computer center 212 may control other operational parameters associated with automated filling station network without being located near the automated filling station. The network also enhances customer convenience, reduces labor costs and hazards to personnel and reduces operating costs and fuel prices. The network thereby realizes many of the potential advantages of automated filling stations that have not been achieved in conventional systems.

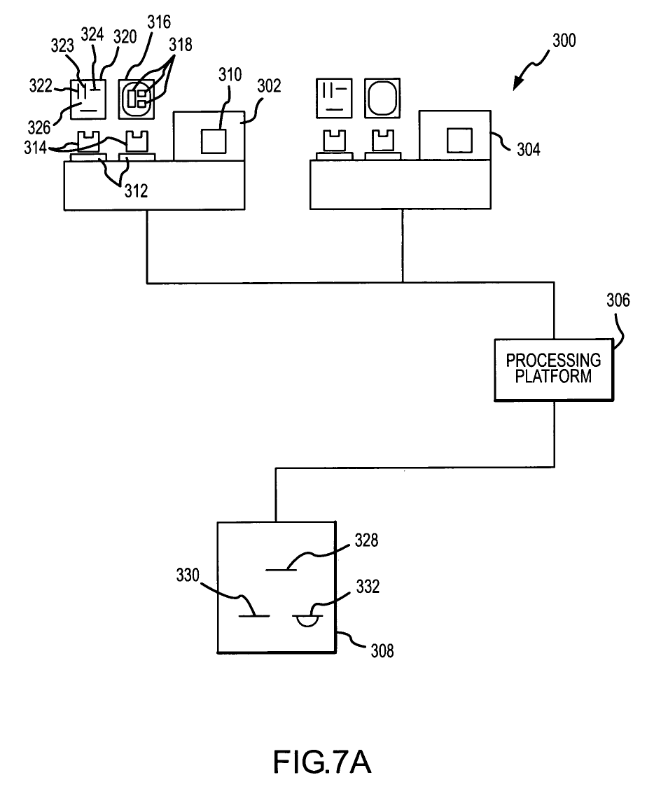

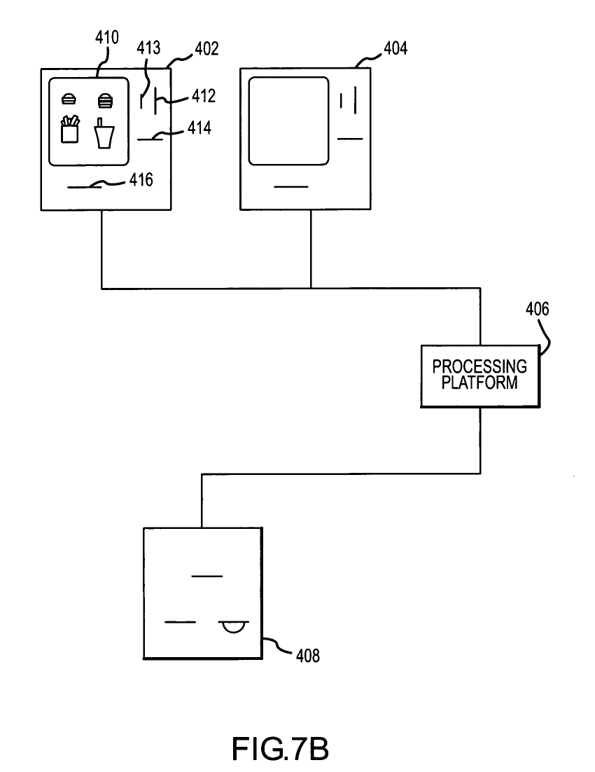

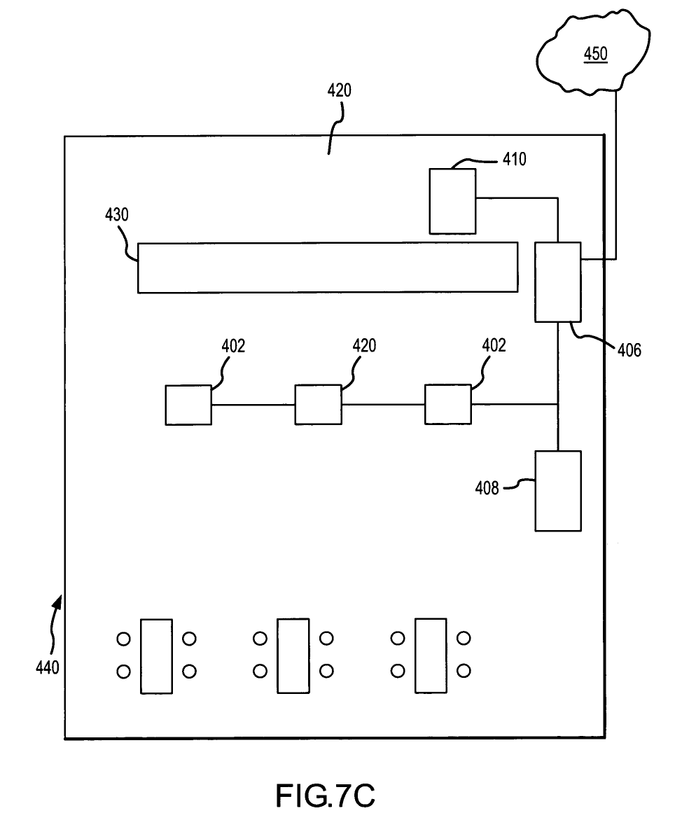

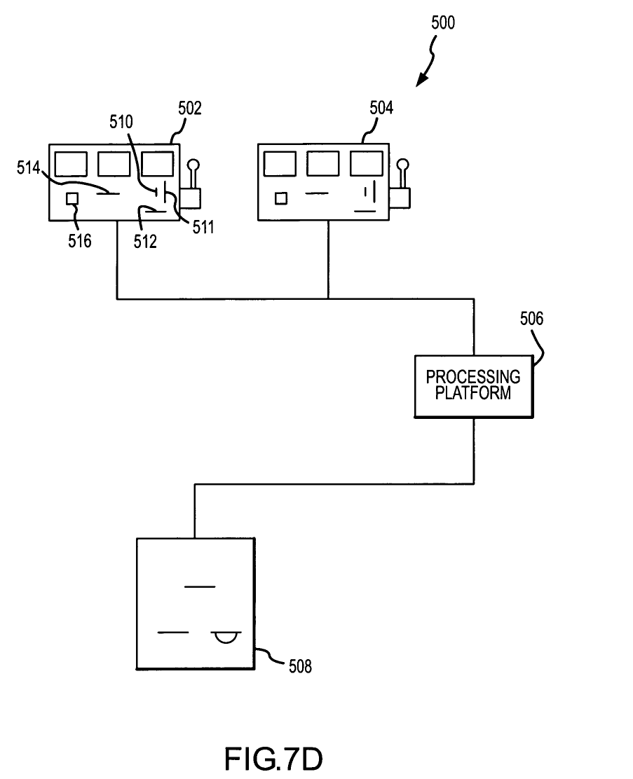

FIG. 7A illustrates an automated transaction processing system 300 in accordance with the present invention. The system 300 may be implemented, for example, in connection with a retail store such as a grocery store. The system includes two or more automated checkout stands 302 and 304 (only two shown), a processing platform 306 such as a server or other computer, and one or more money dispensing machines 308 (only one shown). It will be appreciated that a one-to-one correspondence is not required between the automated checkout stands 302 and 304 and the money dispensing machine(s) 308. In this regard, it is anticipated that each money dispensing machine 308 may be associated with multiple stands 302 and 304, thereby reducing stocking, maintenance and security associated with the machine(s) 308. Such architecture may be particularly convenient where a significant portion of the transactions are credit card transactions. Moreover, although the processing platform 306 will be described as a separate platform, various functions of the platform 306 may be incorporated into the individual stands 302 or 304 and the money dispensing machine 308. Additionally, although the money dispensing machine 308 is shown as being separated from the stands 302 and 304, it should be appreciated that the money dispensing machine may be disposed proximate to the stands 302 and 304 or incorporated into a single structure. Each of the noted components will be described in turn below.

Each of the illustrated stands 302 and 304 includes a barcode scanner 310 or other device for identifying the items to be purchased. In the illustrated self-service checkout stand environment, the customer can scan items to be purchased using the scanner 310 and then place the items in bags 314 associated with scales 312 or other sensors. The scales 312 provide feedback to the system 300 that processing of a particular item has been completed and may allow for identification of certain scanning errors. Each of the illustrated stands 302 and 304 further includes a user interface unit 316 and a payment processing console 320. The unit 316 may include a touch screen, keypad, microphone or any other mechanism by which inputs may be received from a customer. In the illustrated embodiment, the unit 316 is a touch screen monitor which displays a number of user prompts 318 by which the user can initiate transactions, enter any necessary product information and indicate payment preferences. The illustrated console 320 includes a coin receptor 322, a credit card swiper 323, a paper money acceptor 324 and dispenser 326 for dispensing a receipt which may include a cash back code as will be described below. The console 320 may further include a ticket reader or other mechanism for receiving a customer code, e.g., from a prior transaction, which code can be associated with a money due amount that can be credited towards the current transaction.

In operation, a customer may first use the user interface unit 316 to initiate a checkout procedure. The user can then scan each of the items to be purchased using the scanner 310 and place the items into the bags 314. When all items have been scanned, the customer can use the unit 316 to indicate that the scanning is complete and select a payment option. The user can then use the console 320 to pay by credit card or to insert coins and/or paper bills for payment. In the case of money payments, change may be due to the customer. In such cases, a change back code may be issued by the dispenser 326. For example, the code may be a numeric code, alphabetic code, or alphanumeric code. Alternatively, the code may be encoded into a barcode pattern. It will be appreciated that many other codes are possible. In the illustrated implementation, the dispenser 326 preferably provides a printed barcode to the customer on a receipt.

The stands 302 and 304 are interconnected to processing platform 306 by way of any appropriate network such as a local area network or a wide area network which may include wireless and/or wireline links. Code information is transmitted from the stands 302 and 304 to the platform 306. Such code information includes information sufficient to associate a customer code with a corresponding change due amount. The platform 306 can store this information for a variety of purposes. For example, such information may be stored as a credit that the customer can use on a subsequent visit to the store. The platform 306 can also communicate this information to the one or more money dispensing machines 308.

The illustrated money dispensing machine 308 includes a ticket reader 328, a bill dispenser 330 and a coin dispenser 332. The ticket reader 328 may be, for example, a barcode reader. Alternative types of code readers may be provided depending on the nature of the code, e.g., a keyboard for receiving a numeric, alphabetic or alphanumeric code, a magnetic reader, an optical reader or the like. The customer uses the ticket reader 328 in the illustrated embodiment to read the barcode issued at the stands 302 and 304. the machine 308 then dispenses bills and/or coins in an amount equal to the change due to the customer.

FIG. 7B shows an alternative implementation of the invention in connection with a transaction processing system 400 of a fast food restaurant. The illustrated system includes a number of order input kiosks 402 and 404, a processing platform 406 and a money dispensing machine 408. The processing platform 406 and the money dispensing machine 408 may function as described above in connection with FIG. 7A and such description will not be repeated. The illustrated kiosks include a user interface unit 410, a coin acceptor 412, a credit card acceptor 413, a bill acceptor 414, and a ticket dispenser 416. In the illustrated example, the user interface unit 410 comprises a touch screen that a customer can use to enter an order. The customer can then use the receptors 412-414 to enter a payment. Although not shown, the kiosks 402 and 404 may further include a ticket reader for reading a ticket having a code indicating a balance from a prior transaction or money deposit.

In operation, a customer uses the user interface unit 410 to enter an order, indicate the completion of an order and indicate a desired method of payment. The user can then insert coins, paper bills, credit cards, coded tickets, or some combination thereof, in payment. If no change is due, the dispenser 416 is used to generate a receipt. In cases where change is due, the dispenser 416 may further issue a code, for example, in the form of a barcode. The customer can use this ticket at the money dispensing machine 408 to receive change in the form of coins and/or bills.

FIG. 7c shows an exemplary fast food restaurant 440. As shown, the fast food restaurant 440 includes a plurality of order input kiosks 402 that may be utilized to receive input orders from a plurality of customers. As shown, the order input kiosks 402 are operatively interconnected to a controller 406. The controller 406 is further operative to provide order information inputs from the order input kiosk 402 to an output device (e.g., monitor 410 or other device) in a kitchen area 420 of the restaurant 440. As will be appreciated, this enables restaurant staff to fill the orders associated with inputs from the order input kiosk 402.

Once the customer has placed an order at one of the order input kiosks 402, they may proceed to the counter 430 to receive the food items they have ordered. In this regard, the restaurant staff may fill orders in a predetermined order and/or utilizing order reference numbers such that the customer receives the food items they ordered. As will be appreciated, the customer's food order can be picked up without requiring the handling/exchange of money. At this time, the customer may proceed to the money dispensing machine 408 to receive their change, or, retain their code, which may be in the form of a ticket, for later transactions at the fast food restaurant 440.

As shown, the controller 406 may be interconnected to a network 450 by any suitable link 452. In this regard, an offsite centralized platform (e.g., server) may be utilized to maintain transaction records including code information and balances associated with that code information. As will be appreciated, this may permit a customer who retains code information to visit another restaurant that accepts such code information. In this regard, a customer may forego receiving change from the money dispensing machine 408 and opt to utilize their balance at the same restaurant 440 or another restaurant at their discretion. For instance, a fast food restaurant chain may accept stored balances/credit at other locations.

FIG. 7D illustrates a transaction processing system 500 in accordance with the present invention in the context of a gaming establishment such as a casino. The system includes a number of gaming machines 502 and 504, a processing platform 506 and a money dispensing machine 508. The processing platform 506 and the money dispensing machine 508 may function substantially as described above and such description will not be repeated. Each of the illustrated machines 502 and 504 include a coin acceptor 510, a credit card reader 511 and a bill acceptor 512. Although not illustrated, the machines 502 and 504 may also include a ticket reader for reading a coded ticket. The gaming machines further include a ticket dispenser 514.

In operation, a user can enter a payment via one or more of the elements of 510-512. The user then uses the gaming machine in conventional fashion, depending on the nature of the gaming machine. When the user is finished with the gaming machine 502 or 504, the user can provide an input, such as by pressing button 516 to indicate that the gaming transaction is complete. The machine 502 or 504 then issues a ticket having a code printed thereon, such as a barcode. The user can then take the coded ticket to the machine 508 where it is read and the user's winnings or remaining balance can be distributed to the user in the form of paper bills and/or coins.

While various implementations of the present invention have been described in detail, it is apparent that further modifications and adaptations of the invention will occur to those skilled in the art. However, it is to be expressly understood that such modifications and adaptations are within the spirit and scope of the present invention.

1. A money managing system for use in a food service business, comprising:
at least one transaction processing terminal having:
a user interface for receiving a food order;
a payment receiving device for receiving payment for said food order; and
a code generator for generating code information including a code and money amount due associated with said food order and said payment; and
a money dispensing machine having:
an input device for receiving said code; and
a dispenser for dispensing money in said money amount due.

2. The system of claim 1, further comprising:
a processor operatively interconnected to said at least one transaction processing terminal and said money dispensing machine, said processor being operative to receive and store said code information.

3. The system of claim 2, wherein said processor is operatively interconnected to a plurality of transaction processing terminals and a plurality of money dispensing machines.

4. The system of claim 3, wherein said processor is interconnected to said pluralities of transaction processing terminals and said money dispensing machines located at at least two food service businesses at separate locations.

5-7. (canceled)

8. The system of claim 1, wherein said user interface comprises at least one of:
a key pad;
a display screen;
a touch display screen; and
a microphone.

9. (canceled)

10. The system of claim 1, wherein said payment receiving device is operative to receive at least one of:
paper currency;
coins;
credit cards;
debit cards; and
system credit.

11. The system of claim 1, wherein said code generator is operative to dispense a ticket.

12. (canceled)

13. (canceled)

14. The system of claim 11, wherein said ticket is machine readable.

15-17. (canceled)

18. The system of claim 1, wherein said dispenser is operative to dispense paper currency and coins.

19. The system of claim 1, wherein said at least one transaction processing terminal and said money dispensing machine are located at separate locations at said food service business.

20. The system of claim 1, wherein money dispensing machine is operative to receive code information from a plurality of said transaction processing terminals.

21. The system of claim 1, wherein said money dispensing machine is further operative to function as an automated teller machine (ATM).

22. A money managing system for use in connection with a food service business, comprising:
at least one transaction processing terminal operative for executing a food purchase transaction and generating a voucher associated with the purchase transaction; and
a money dispensing machine operative to obtain information from said voucher and dispense money in an amount associated with said voucher.

23. The system of claim 22, wherein said purchase transaction comprises the purchase of food items in a restaurant setting.

24. The system of claim 22, wherein said transaction processing terminal further comprises:
a user interface for receiving a purchase order; and
a payment receiving device for receiving payment for said purchase order.

25. (canceled)

26. The system of claim 22, wherein said voucher includes code information.

27. The system of claim 26, wherein said code information includes a code and a money amount associated with said purchase transaction.

28. The system of claim 22, wherein said transaction processing terminal and said money dispensing machine are located at separate locations within said food service business.

29. The system of claim 28, wherein said money dispensing machine is interconnected to a plurality of said transaction processing terminals.

30. A money managing system for use in a food service business, comprising:
at least one transaction processing terminal operative for executing a food order;
a payment receiving device for receiving payment for said food order;
a money dispensing machine to operative dispense money in an amount associated with said food order and said payment; and
a processor operatively interconnected to said transaction processing terminal, said processor being operative to generate an output associated with said food order in a kitchen area of said food service business.

31. (canceled)

32. The system of claim 30, wherein said transaction processing terminal and said money dispensing machine are located at separate locations within said food service business.

33. The system of claim 32, further comprising:
an output device associated with said transaction processing terminal and said payment receiving device for generating an output associated with money amount due.

34. (canceled)

35. (canceled)

36. The system of claim 33, wherein said output device generates code information associated with said money amount due.

37. The system of claim 36, wherein said money dispensing machine further includes:
an input for receiving said code information.

38. (canceled)

39. (canceled)

40. A money managing system for use in a food service business, comprising:
at least one order kiosk operative to:
receive a food order and payment for said food order from a customer;
provide a receipt to said customer, said receipt including a code associated with a money amount due; and
store said code and said money amount due to a record; and
a money dispensing machine operative to:
receive said code;
access said record based on said code; and
dispense money equal to said money amount due.

41. (canceled)

42. The system of claim 40, wherein said at least one order kiosk and said money dispensing machine are located at separate locations within said food service business.

43. The system of claim 40, further comprising:
a processor operatively interconnected to said at least one food order kiosk and said money dispensing machine, wherein said processor is operative to provide access to said record.

44. The system of claim 43, wherein said processor is located at a location remote to said food service business.

45. (canceled)

46. A method for managing money in a food service business, comprising:
receiving a food order and payment from a customer at an automated processing terminal;
determining a money amount due to said customer;
providing code information to said customer, said code information including a code and said money amount due;
receiving said code information at a money dispensing machine; and
dispensing money equal to said money amount due.

47-49. (canceled)

50. The method of claim 46, wherein said receiving code information step is performed at a location separate from said providing code information step.

51. The method of claim 46, wherein said providing code information step is performed at a first food service location and said receiving said code information is performed at a second food service location.

52-53. (canceled)
